(19) United States
(12) Patent Application Publication
(10) Pub. No.: US 2025/0267172 A1
(43) Pub. Date: Aug. 21, 2025

(54) OBJECT REGULATION METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventor: Hao KONG, Beijing (CN)

(21) Appl. No.: 19/038,632

(22) Filed: Jan. 27, 2025

(30) Foreign Application Priority Data
Feb. 18, 2024 (CN) 202410180728.0

(51) Int. Cl. H04L 9/40; G06F 16/903; G06F 16/906

(52) U.S. Cl. CPC H04L 63/20; G06F 16/90335; G06F 16/906

(57) ABSTRACT

The present disclosure provides an object regulation method, electronic device and a non-transitory computer-readable storage medium. The method includes: obtaining a policy group, where the policy group includes target object information and at least one policy, and the policy includes: a regulation condition and a regulation action that correspond to each other; generating a query task based on the target object information and the regulation condition, and performing the query task to obtain regulation data; and performing the regulation action corresponding to the regulation condition on a target object corresponding to the target object information when the regulation data meets the regulation condition. In this way, after a user configures the policy group, the target object may be intelligently regulated without subsequent human participation, thereby effectively improving regulation efficiency of the target object, and improving regulation accuracy.

### CROSS-REFERENCE TO RELATED APPLICATIONS

This application claims the priority to and benefits of the Chinese Patent Application, No. 202410180728.0, which was filed on Feb. 18, 2024. The aforementioned patent application is hereby incorporated by reference herein in its entirety.

### TECHNICAL FIELD

Embodiments of the present disclosure relates to an object regulation method, electronic device and a non-transitory computer-readable storage medium.

### BACKGROUND

Dynamic regulation is widely used in a variety of scenarios in various fields, to regulate objects based on actual situations, thereby improving performance of the objects as much as possible. For example, a web page may be regulated to increase a click-through rate of the web page.

In the prior art, regulation of the objects in the various fields is usually implemented manually. For example, when the number of clicks on the web page is low, a position of the web page may be adjusted to a front position for display, a size of the web page may be increased, etc., to highlight the web page, thereby increasing the click-through rate of the web page.

However, the above-mentioned solutions have problems of low regulation efficiency and regulation accuracy.

### SUMMARY

Embodiments of the present disclosure provide an object regulation method and device, to improve regulation accuracy and regulation efficiency.

According to a first aspect, an embodiment of the present disclosure provides an object regulation method, including:
obtaining a policy group, where the policy group includes target object information and at least one policy, and the policy includes: a regulation condition and a regulation action that correspond to each other;
generating a query task based on the target object information and the regulation condition, and performing the query task to obtain regulation data; and
performing the regulation action corresponding to the regulation condition on a target object corresponding to the target object information when the regulation data meets the regulation condition.

According to a second aspect, an embodiment of the present disclosure provides an object regulation apparatus, including:
a policy group obtaining module configured to obtain a policy group, where the policy group includes target object information and at least one policy, and the policy includes: a regulation condition and a regulation action that correspond to each other;
a regulation data obtaining module configured to generate a query task based on the target object information and the regulation condition, and perform the query task to obtain regulation data; and
a regulation execution module configured to perform the regulation action corresponding to the regulation condition on a target object corresponding to the target object information when the regulation data meets the regulation condition.

According to a third aspect, an embodiment of the present disclosure provides an electronic device. The electronic device includes: at least one processor and a memory,
where the memory stores computer-executable instructions; and
the at least one processor executes the computer-executable instructions stored in the memory, to cause the electronic device to implement the method in the first aspect.

According to a fourth aspect, an embodiment of the present disclosure provides a computer-readable storage medium storing computer-executable instructions that, when executed by a processor, cause a computing device to implement the method in the first aspect.

According to a fifth aspect, an embodiment of the present disclosure provides a computer program for implementing the method in the first aspect.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is a schematic diagram of a structure of a policy group according to an embodiment of the present disclosure;

FIG. 2 is a flowchart of steps of an object regulation method according to an embodiment of the present disclosure;

FIG. 3 is a schematic diagram of state transition of a policy group according to an embodiment of the present disclosure;

FIG. 4 is a schematic diagram of a deletion relationship of a policy group according to an embodiment of the present disclosure;

FIG. 5 is a schematic diagram of states of a regulation action according to an embodiment of the present disclosure;

FIG. 6 is a flowchart of steps of another object regulation method according to an embodiment of the present disclosure;

FIG. 7 is a block diagram of a structure of an object regulation apparatus according to an embodiment of the present disclosure; and

FIG. 8 is a block diagram of a structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All the other embodiments obtained by those of ordinary skill in the art based on the embodiments of the present disclosure without any creative effort shall fall within the scope of protection of the present disclosure.

The present disclosure is used for regulation of objects. The objects herein may be any objects in any field, including: a physical object and a virtual object. The regulation may be regulation of any of the attributes of the objects. For example, a display attribute of a web page may be regulated.

In some technical solutions, the objects may be regulated based on human experience. However, this results in a slow regulation speed and low regulation efficiency. In addition, regulation accuracy is low due to human negligence.

To resolve the above technical problems, embodiments of the present disclosure implement intelligent regulation based on policy group parsing. Specifically, one or more pre-configured policy groups may be parsed to generate a query task, so that regulation data is obtained by using the query task. Then, when the regulation data meets one or more regulation conditions in the policy group, a regulation action corresponding to the regulation condition is performed. In this way, after a user configures the policy group, a target object may be intelligently regulated without subsequent human participation, thereby effectively improving regulation efficiency of the target object, and improving regulation accuracy of the target object.

It can be learned that regulation logic in the embodiments of the present disclosure is controlled by the policy group, and the user may flexibly configure the policy group according to actual requirements, to flexibly regulate the target object. In some examples, the user may configure target object information in the policy group to specify the target object, may configure a policy execution condition in the policy group to specify an execution condition of the policy group, may configure a regulation target in the policy group to specify that the target object is regulated to meet the regulation target, and may configure a regulation condition and a corresponding regulation action in the policy group as a policy to perform the corresponding regulation action when regulation data of the target object meets the regulation condition. The regulation logic is flexibly controlled based on these configuration items in the policy group, to implement rich and diverse regulation policies.

The technical solutions in the embodiments of the present disclosure and how the technical solutions of the present disclosure solve the above technical problem are described below in detail with specific embodiments. The following several specific embodiments may be combined with each other, and details about same or similar concepts or processes may not be described in some embodiments again. The embodiments of the present disclosure are described below with reference to the accompanying drawings.

In the embodiments of the present disclosure, regulation and control may be performed based on one or more policy groups. Each policy group includes policy group information and at least one policy. The policy group information is used to describe information about the policy group, including but not limited to: target object information targeted by the policy group, a regulation target of the policy group, and a policy execution condition of the policy group.

The target object information is information about the target object for which regulation is performed based on the policy group. For example, the target object information may be a web page identifier or address, etc., and is used to indicate that the policy group is used to regulate and control a web page corresponding to the web page identifier or address.

The regulation target is used to indicate a target factor and a target value for performing regulation and control based on the policy group. For example, the regulation target is used to indicate to perform regulation and control on the web page based on the policy group, so that the number of clicks on the web page reaches M. Therefore, the target factor is the number of clicks and the target value is M.

The policy execution condition is used to indicate whether to execute the policy group, and can be used to describe, in a plurality of dimensions, whether to execute the policy group. For example, the policy execution condition may include: an execution period, whether cold start is supported, and a scope limit on the regulation action. Therefore, the policy group is executed when the execution period of the policy group is reached. The policy group is not executed when the execution period of the policy group is not reached. When cold start is supported, the policy group may be executed at initialization of a system. When cold start is not supported, the policy group may not be executed at initialization of a system. The policy group is not executed when a last regulation action does not exceed the scope limit. The policy group is executed when a last regulation action exceeds the scope limit.

Each policy includes one or more regulation conditions. The regulation action in the policy may be performed on the target object corresponding to the target object information when the regulation data of the target object information meets all the regulation conditions in the policy, to regulate the target object one time. The regulation action in the policy is not performed on the target object corresponding to the target object information when the regulation data of the target object information does not meet at least one regulation condition in the policy.

It can be understood that different policies may correspond to different regulation actions and/or different regulation conditions. The regulation condition is used to indicate a condition under which the regulation action is performed, and the regulation condition may include a condition to be met by at least one regulation factor of the target object. The regulation action is used to indicate a target attribute of the target object to be regulated, and a regulation direction and a regulation magnitude of the target attribute.

FIG. 1 is a schematic diagram of a structure of a policy group according to an embodiment of the present disclosure. Refer to FIG. 1, a policy group A includes policy group information A0 and policies B1 and B2. The policy group information A0 includes: target object information A1, a regulation target A2, and a policy execution condition A3. The policy B1 includes regulation conditions C1 and C2, and a corresponding regulation action D1. The policy B2 includes regulation conditions C3, C4, and C5, and a corresponding regulation action D2. Therefore, the policy group A may be executed when the policy execution condition A3 is met. Specifically, the regulation action D1 may be performed on a target object corresponding to the target object information A1 when regulation data corresponding to the target object information A1 meets the regulation conditions C1 and C2, and the regulation action D2 may be performed on the target object corresponding to the target object information A1 when the regulation data corresponding to the target object information A1 meets the regulation conditions C3, C4, and C5.

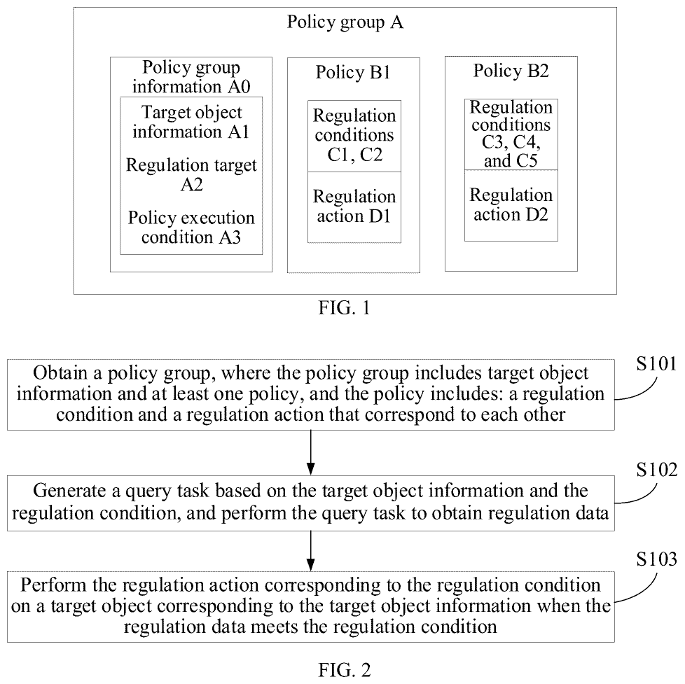

FIG. 2 is a flowchart of steps of an object regulation method according to an embodiment of the present disclosure. Refer to FIG. 2, the object regulation method includes:

S101: Obtain a policy group, where the policy group includes target object information and at least one policy, and the policy includes: a regulation condition and a regulation action that correspond to each other.

Herein, one or more policy groups may be obtained. A quantity of policy groups is not limited in this embodiment of the present disclosure. When there are a plurality of policy groups, regulation actions may be performed on a plurality of target objects based on the plurality of policy groups at a time, to regulate the plurality of target objects in batches. The regulation action is used to indicate a target attribute to be regulated, and a regulation direction and a regulation magnitude of the target attribute. For example, the regulation action may be increasing a size of the target object by 100, where the size of the target object is the target attribute, “increasing” is the regulation direction, and 100 is the regulation magnitude.

The policy group is pre-configured by a user, and a policy group configuration interface may be provided, so that the user configures the one or more policy groups in the policy group configuration interface. Specifically, the user may enter various information included in each policy group into the policy group configuration interface, for example, the target object information, the policy, and the regulation condition and the regulation action in the policy.

In some implementations, the policy group has two states: an enabled state and a disabled state. In this case, obtaining of the policy group may include: obtaining a policy group in an enabled state and a policy in the enabled state from the policy group in the enabled state. In this way, a regulation policy may be controlled based on a state of the policy group and a state of the policy, to further improve regulation flexibility.

It can be understood that the state of the policy group and the state of the policy may be flexibly set by the user. Certainly, in addition to being set by the user, the states may be further intelligently adjusted in this embodiment of the present disclosure. When the user sets all policies in the policy group to the disabled state, all the policies in the policy group are in the disabled state. In this case, the policy group in which the policies are in the disabled state may be intelligently adjusted to the disabled state, so that the policy group is in the disabled state. When the user adjusts at least one policy in the policy group in which all the policies are in the disabled state to the enabled state, the at least one policy in the policy group is in the enabled state. In this case, the policy group may be intelligently adjusted to the enabled state, so that the policy group is in the enabled state.

It can be learned that in this embodiment of the present disclosure, the states may be adjusted by the user and be further intelligently adjusted, to improve intelligence of the states, thereby reducing operation complexity of the user.

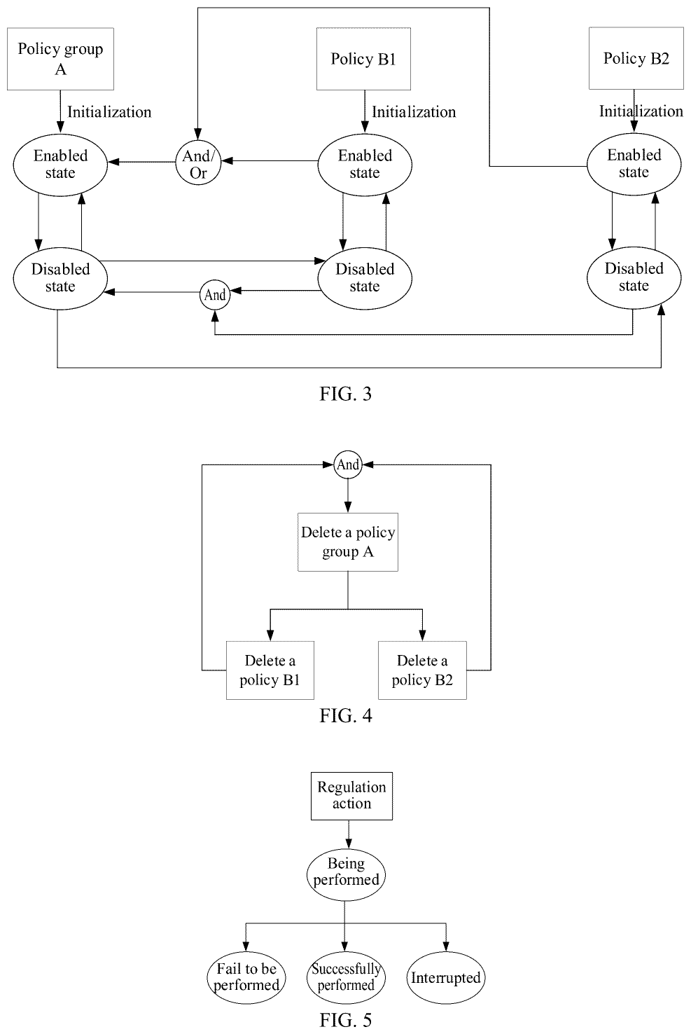

FIG. 3 is a schematic diagram of state transition of a policy group according to an embodiment of the present disclosure. Refer to FIG. 3, the policy group A includes policies B1 and B2. After the policy group A is created, the policy group is initially in the enabled state, and the policies B1 and B2 are in the enabled state.

The state of the policy group A may be flexibly switched between the enabled state and the disabled state, and both the policy B1 and the policy B2 may be flexibly switched between the enabled state and the disabled state.

When the user adjusts the state of policy group A from the enabled state to the disabled state, the policies B1 and B2 in the policy group A may also be intelligently adjusted to the disabled state.

Certainly, the state of the policy B1 and the state of the policy B2 are independent of each other. When the user adjusts the state of the policy B1 from the enabled state to the disabled state, or adjusts the state of the policy B1 from the disabled state to the enabled state, the state of the policy B2 is unaffected and remains in its current state. Similarly, when the user adjusts the state of the policy B2 from the enabled state to the disabled state, or adjusts the state of the policy B2 from the disabled state to the enabled state, the state of the policy B1 is unaffected and remains in its current state.

However, the state of the policy group A is affected by those of the policies B1 and B2. The policy group A is in the enabled state when the policy B1 is in the enabled state and/or the policy B2 is in the enabled state. The policy group A is in the disabled state when the policy B1 is in the disabled state and the policy B2 is in the disabled state.

It can be understood that the policy group may be deleted when the policy group is in any state, and the policies may be deleted when the policies are in any state. FIG. 4 is a schematic diagram of a deletion relationship of a policy group according to an embodiment of the present disclosure. Refer to FIG. 4, the policies B1 and B2 are deleted when the user deletes the policy group A. Alternatively, the policy group A is deleted when the user deletes the policies B1 and B2.

S102: Generate a query task based on the target object information and the regulation condition, and perform the query task to obtain regulation data.

The query task is used to query the regulation data that is required when the target object is regulated. Therefore, the target object needs to be specified with reference to the target object information and the regulation data needs to be specified based on the regulation condition.

In some implementations, the policy group further includes a policy execution condition. The policy execution condition includes at least one of: whether cold start is supported, an execution period, and a scope limit on the regulation action. Therefore, a generation process of the query task may include: obtaining current scenario information based on the policy execution condition first; and generating the query task based on the target object information and the regulation condition when the current scenario information meets the policy execution condition. In this way, execution of the policy group may be further controlled based on the policy execution condition, to further flexibly regulate the target object. The policy execution condition may be set flexibly and is not limited to the examples above.

It can be understood that the current scenario information corresponds to the policy execution condition. When the policy execution condition includes whether cold start is supported, whether current start is cold start needs to be obtained as the current scenario information. When the policy execution condition includes the execution period, current time information needs to be obtained as the current scenario information. When the policy execution condition includes the scope limit on the regulation action, a regulation result of a last regulation action needs to be obtained.

When the current scenario information meets the policy execution condition, the query task may be generated based on the target object information and the regulation condition, to perform regulation. When the current scenario information does not meet at least one of the above policy execution conditions, no query task is generated and no regulation is performed.

The query task usually exists in a form of a query statement. Therefore, the query statement may be generated by using the following steps: extracting a regulation factor from the regulation condition first; determining a corresponding data table, a first field of the regulation factor in the data table, and a second field corresponding to the target object information in the data table based on the regulation factor; and finally, generating a query statement corresponding to the query task based on the first field, the second field, and the data table, where the query statement is used to read the first field from the data table when the second field matches the target object information.

It can be understood that the regulation condition is used to indicate a condition met by the regulation factor. Therefore, the regulation factor is indicated in the regulation condition, and may be extracted from the regulation condition. For example, the regulation condition may be that a click-through rate is greater than 100. In this case, the click-through rate may be extracted from the regulation condition as the regulation factor.

The first field is a field of the regulation factor in the data table. When the first field is used as the regulation factor when the regulation condition is configured in the policy group, the extracted regulation factor may be directly queried in the data table. When the regulation factor used when the regulation condition is configured in the policy group is different from the first field, a mapping relationship between the first field and the regulation factor needs to be established in advance to convert the extracted regulation factor into the first field, and then the query statement is generated. In addition, a mapping relationship between the first field and the data table and a mapping relationship between the target object information and the second field may be further set to determine the data table again after the first field is determined, thereby generating the query statement with reference to the first field, the second field, and the data table.

The data table may be pre-generated offline. Specifically, an object information table and a first field table may be associated to generate the data table, and the object information table and the first field table may be associated based on object information in the object information table.

S103: Perform the regulation action corresponding to the regulation condition on a target object corresponding to the target object information when the regulation data meets the regulation condition.

In this embodiment of the present disclosure, one policy group includes one or more policies, and each policy may include one or more regulation conditions and one regulation action. When the regulation data meets all regulation conditions of a policy, a regulation action of the policy is performed on the target object. When the regulation data does not meet at least one regulation condition of a policy, a regulation action of the policy is not performed on the target object. In this way, the regulation action of the policy in which all regulation conditions are met by the regulation data may be performed on the target object. For example, for the policy group shown in FIG. 1, when the regulation data meets the regulation conditions C1, C2, and C3, the regulation action D1 of the policy B1 is performed because the regulation data meets all the regulation conditions of the policy B1. However, the regulation action D2 of the policy B2 is not performed because the regulation data does not meet the regulation conditions C4 and C5.

In conclusion, target policies in which regulation conditions are met by the regulation data may be obtained from the policy group, to perform regulation actions of the target policies one by one. In a process of performing the regulation action, a state of each regulation action may be further set and state management is performed. FIG. 5 is a schematic diagram of states of a regulation action according to an embodiment of the present disclosure. Refer to FIG. 5, after performing of the regulation action starts, the state of the regulation action is “being performed”. The state of the regulation action may be converted from “being performed” to “fail to be performed”, “successfully performed”, or “interrupted”.

In some implementations, the policy group further includes a regulation target. The regulation target includes a target factor and a target value corresponding to the target factor, to indicate that the regulation target is enabling the target factor of the target object to reach the target value. Herein, the regulation condition is associated with the regulation target. Therefore, S103 may include the following step: replacing a value corresponding to the target factor in the regulation condition with the target value to obtain a target regulation condition, and performing the regulation action on the target object when the regulation data meets the target regulation condition. For example, the regulation condition may be that a regulation factor P1 is greater than 2 times a target factor P2. When the target value of the target factor is 100, the target regulation condition obtained after the value of the target factor is replaced is that the regulation factor P1 is greater than 200.

It can be learned that the regulation condition is associated with the regulation target in this embodiment of the present disclosure. In this case, the regulation condition may be referred to as a dynamic regulation condition, which changes with the regulation target. Certainly, the regulation condition may be not associated with the regulation target, and is a fixed condition. In this embodiment of the present disclosure, the dynamic regulation condition may be implemented, to further improve regulation flexibility.

In some implementations, the policy group further includes a regulation weight corresponding to each policy. Therefore, a plurality of policies in the policy group may be further classified into a plurality of groups based on regulation directions of regulation actions, and regulation actions in each group correspond to one regulation direction. Then, the regulation weights of the policies are adjusted on a per-group basis. Finally, the regulation actions are combined based on the regulation weights to obtain a comprehensive regulation action, and the comprehensive regulation action is performed on the target object.

The regulation direction is used to indicate to increase or decrease the target attribute of the target object. Therefore, policies in which regulation actions are used for increasing a same target attribute may be classified into one group, and policies in which regulation actions are used for decreasing a same target attribute may be classified into another group.

After the groups are obtained, the regulation weights of the policies in each group may be properly adjusted, to adjust an impact of the policies on regulation. For example, regulation weights of some policies in each group may be decreased, to prevent the target object from being excessively regulated in a same regulation direction, thereby avoiding excessive regulation.

The adjusted regulation weights of some policies each may be a regulation weight of any policy, and may be adjusted by using the following steps: first classifying a plurality of policies of each group into a plurality of sub-groups based on regulation actions, where regulation actions corresponding to each sub-group are the same; and decreasing a regulation weight of a target policy in each sub-group, where the target policy is a policy other than a policy with a largest regulation weight in the sub-group. In this way, a weight of a policy with a small impact may be further decreased, so that the target object is subjected to a same adjustment again after a regulation action with a large regulation weight in the group.

“The regulation actions are the same” may be that target attributes are the same and regulation directions are the same. For example, when a group includes policies B1, B2, B3, and B4, regulation actions of the policies are respectively increasing an attribute P1 of the target object, increasing an attribute P1 of the target object, increasing an attribute P2 of the target object, and increasing an attribute P2 of the target object, therefore, the policies B1 and B2 may be classified into one sub-group, and the policies B3 and B4 may be classified into one sub-group. For the sub-group including the policies B1 and B2, if a regulation weight of the policy B1 is greater than a regulation weight of the policy B2, the policy B2 is used as a target policy to decrease the regulation weight of the policy B2. Similarly, for the sub-group including the policies B3 and B4, if a regulation weight of the policy B3 is less than a regulation weight of the policy B4, the policy B3 is used as a target policy to decrease the regulation weight of the policy B3.

After the regulation weight of each policy in the policy group is adjusted, the regulation actions of the policies may be combined based on the regulation weights of the policies, to obtain the comprehensive regulation action, to perform the comprehensive regulation action on the target object. In this way, a quantity of times of performing the regulation actions may be reduced as much as possible, thereby improving regulation efficiency of the target object.

The above-mentioned “combining” may be construed as weighing adjustment magnitudes of a same target attribute based on the regulation weights to obtain a comprehensive adjustment magnitude of the target attribute. In this way, comprehensive adjustment magnitudes of all target attribute in the policy group may obtained, to respectively adjust the target attributes. For example, the regulation actions in the policy group include D1 to D5, and corresponding weights thereof are respectively W1 to W5. D1 is used to increase a target attribute P1 by N1, D2 is used to increase the target attribute P1 by N2, D3 is used to decrease a target attribute P2 by N3, D4 is used to increase the target attribute P2 by N4, and D5 is used to increase a target attribute P3 by N5. Therefore, the regulation actions D1 and D2 may be combined to obtain a first comprehensive regulation action, and the first comprehensive regulation action is used to increase the target attribute P1 by W1×N1+W2×N2. The regulation actions D3 and D4 may be combined to obtain a second comprehensive regulation action, and the second comprehensive regulation action is used to decrease the target attribute P2 by W3×N3−W4×N4. The regulation action D4 is used as a third comprehensive regulation action.

Optionally, different decrease magnitudes may be further used for regulation weights of different target regulations. A decrease magnitude of the regulation weight of the target policy in each sub-group is negatively correlated with the regulation weight of the target policy. That is, a larger regulation weight of the target policy indicates a smaller decrease magnitude of the regulation weight of the target policy, and a smaller regulation weight of the target policy indicates a larger decrease magnitude of the regulation weight of the target policy.

For example, the regulation weights may be adjusted by using the following step: arranging the policies in each sub-group in descending order based on the regulation weights, to decrease, starting from the second policy, the regulation weights of the policies one by one, where a decrease magnitude of a regulation weight of a next policy is greater than a decrease magnitude of a regulation weight of a previous policy. For example, a group includes policies B5, B6, and B7, and regulation weights of the policies are in descending order. In this case, the regulation weight of B5 may remain unchanged, and a decrease magnitude of the regulation weight of B6 is less than a decrease magnitude of the regulation weight of B7.

Certainly, a regulation weight of the first policy in each sub-group may also be adjusted with a smallest decrease magnitude, and the first policy is a policy with a largest regulation weight in the sub-group. When the decrease magnitude of the regulation weight of the first policy is 0, the regulation weight of the first policy is not decreased.

In conclusion, the pre-configured policy group may be parsed in this embodiment of the present disclosure, to implement a regulation solution for the target object, thereby implementing intelligent regulation. Therefore, regulation accuracy and efficiency may be improved. In addition, human participation may be further reduced and labor costs are saved.

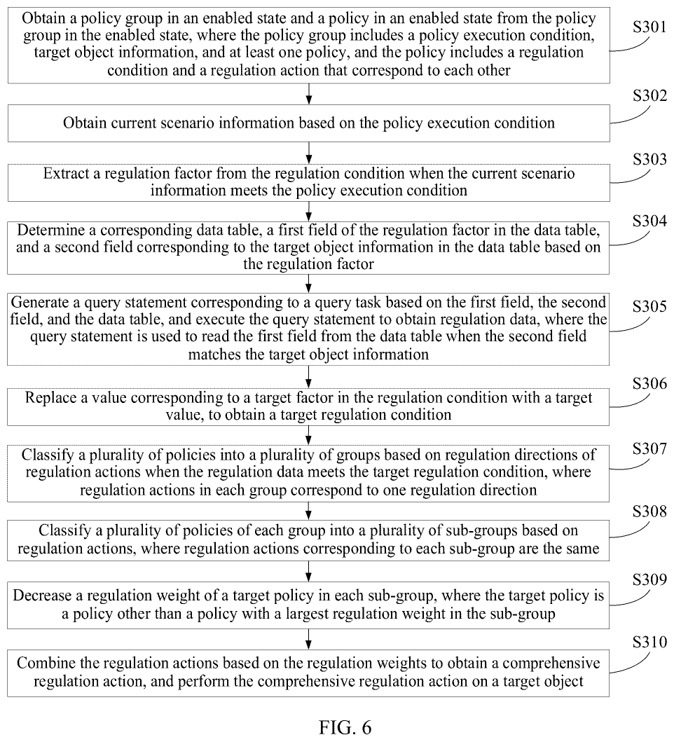

FIG. 6 is a flowchart of steps of another object regulation method according to an embodiment of the present disclosure. Refer to FIG. 6, the object regulation method may include:

S301: Obtain a policy group in an enabled state and a policy in the enabled state from the policy group in the enabled state, where the policy group includes a policy execution condition, target object information, and at least one policy, and the policy includes: a regulation condition and a regulation action that correspond to each other.

S302: Obtain current scenario information based on the policy execution condition.

S303: Extract a regulation factor from the regulation condition when the current scenario information meets the policy execution condition.

S304: Determine a corresponding data table, a first field of the regulation factor in the data table, and a second field corresponding to the target object information in the data table based on the regulation factor.

S305: Generate a query statement corresponding to a query task based on the first field, the second field, and the data table, and execute the query statement to obtain regulation data, where the query statement is used to read the first field from the data table when the second field matches the target object information.

S306: Replace a value corresponding to a target factor in the regulation condition with a target value, to obtain a target regulation condition.

S307: Classify a plurality of policies into a plurality of groups based on regulation directions of regulation actions when the regulation data meets the target regulation condition, where regulation actions in each group correspond to one regulation direction.

S308: Classify a plurality of policies of each group into a plurality of sub-groups based on regulation actions, where regulation actions corresponding to each sub-group are the same.

S309: Decrease a regulation weight of a target policy in each sub-group, where the target policy is a policy other than a policy with a largest regulation weight in the sub-group.

S310: Combine the regulation actions based on the regulation weights to obtain a comprehensive regulation action, and perform the comprehensive regulation action on a target object.

It should be noted that a sequence of the steps shown in FIG. 6 may be flexibly adjusted independent of each other. In addition, the object regulation method may be explained with reference to the object regulation method shown in FIG. 2. Details are not described herein again.

Corresponding to the object regulation method of the above embodiments, FIG. 7 is a block diagram of a structure of an object regulation apparatus according to an embodiment of the present disclosure. For ease of illustration, only parts related to this embodiment of the present disclosure are shown. Refer to FIG. 7, an object regulation apparatus 400 includes:
a policy group obtaining module 401 configured to obtain a policy group, where the policy group includes target object information and at least one policy, and the policy includes: a regulation condition and a regulation action that correspond to each other;
a regulation data obtaining module 402 configured to generate a query task based on the target object information and the regulation condition, and perform the query task to obtain regulation data; and
a regulation execution module 403 configured to perform the regulation action corresponding to the regulation condition on a target object corresponding to the target object information when the regulation data meets the regulation condition.

Optionally, the regulation data obtaining module 402 is further configured to:
extract a regulation factor from the regulation condition; determine a corresponding data table, a first field of the regulation factor in the data table, and a second field corresponding to the target object information in the data table based on the regulation factor; and generate a query statement corresponding to the query task based on the first field, the second field, and the data table, where the query statement is used to read the first field from the data table when the second field matches the target object information.

Optionally, the policy group further includes: a regulation target, including a target factor and a target value corresponding to the target factor, the regulation condition being associated with the regulation target. The regulation execution module 403 is further configured to:
replace a value corresponding to the target factor in the regulation condition with the target value, to obtain a target regulation condition; and perform the regulation action on the target object when the regulation data meets the target regulation condition.

Optionally, the policy group further includes a regulation weight corresponding to each policy; and the regulation execution module 403 is further configured to:
classify a plurality of policies into a plurality of groups based on regulation directions of regulation actions, where regulation actions in each group correspond to one regulation direction; adjust the regulation weights of the policies on a per-group basis; and combine the regulation actions based on the regulation weights to obtain a comprehensive regulation action, and perform the comprehensive regulation action on the target object.

Optionally, the regulation execution module 403 is further configured to:
classify a plurality of policies of each group into a plurality of sub-groups based on regulation actions, where regulation actions corresponding to each sub-group are the same; and decrease a regulation weight of a target policy in each sub-group, where the target policy is a policy other than a policy with a largest regulation weight in the sub-group.

Optionally, a decrease magnitude of the regulation weight of the target policy in each sub-group is negatively correlated with the regulation weight of the target policy.

Optionally, the policy group further includes a policy execution condition. The regulation data obtaining module 402 is further configured to:
obtain current scenario information based on the policy execution condition; and generate the query task based on the target object information and the regulation condition when the current scenario information meets the policy execution condition.

Optionally, the policy execution condition includes: whether cold start is supported, an execution period, and a scope limit on the regulation action.

Optionally, the policy group obtaining module 401 is further configured to:

obtain a policy group in an enabled state and a policy in the enabled state from the policy group in the enabled state, where the policy group is in a disabled state when all the policies in the policy group are in the disabled state; and the policy group is in the enabled state when at least one policy in the policy group is in the enabled state.

The object regulation apparatus provided in this embodiment may be configured to perform the technical solution of the above object regulation method embodiment. The implementation principle and technical effects thereof are similar, and are not described herein again in this embodiment.

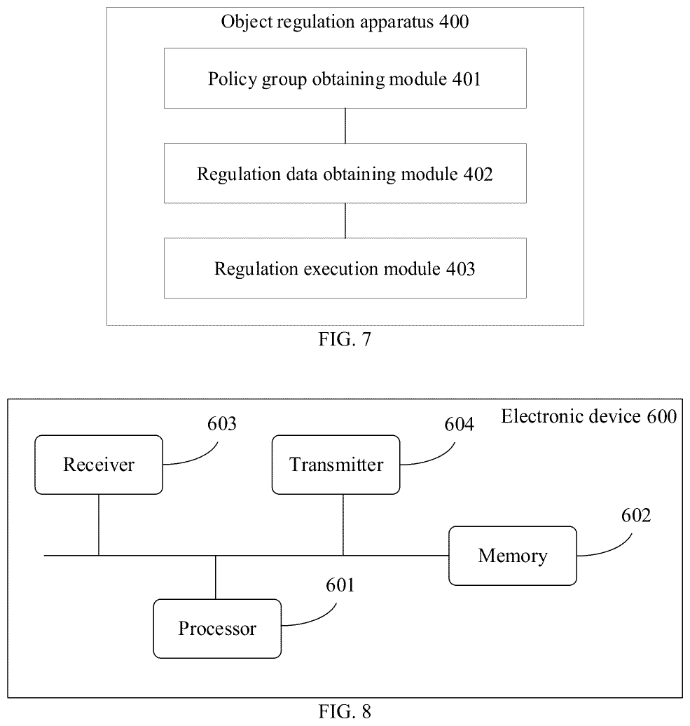

FIG. 8 is a block diagram of a structure of an electronic device according to an embodiment of the present disclosure. The electronic device 600 includes a memory 602 and at least one processor 601.

The memory 602 stores computer-executable instructions.

The at least one processor 601 executes the computer-executable instructions stored in the memory 602, to cause the electronic device 600 to implement the object regulation method as described above.

In addition, the electronic device may further include a receiver 603 and a transmitter 604. The receiver 603 is configured to receive information from other apparatuses or devices and forward the information to the processor 601. The transmitter 604 is configured to transmit information to other apparatuses or devices.

In a first example of a first aspect, an embodiment of the present disclosure provides an object regulation method. The method includes:
obtaining a policy group, where the policy group includes target object information and at least one policy, and the policy includes: a regulation condition and a regulation action that correspond to each other;
generating a query task based on the target object information and the regulation condition, and performing the query task to obtain regulation data; and
performing the regulation action corresponding to the regulation condition on a target object corresponding to the target object information when the regulation data meets the regulation condition.

Based on the first example of the first aspect, in a second example of the first aspect, the generating a query task based on the target object information and the regulation condition includes: extracting a regulation factor from the regulation condition; determining a corresponding data table, a first field of the regulation factor in the data table, and a second field corresponding to the target object information in the data table based on the regulation factor; and generating a query statement corresponding to the query task based on the first field, the second field, and the data table, where the query statement is used to read the first field from the data table when the second field matches the target object information.

Based on the first example of the first aspect, in a third example of the first aspect, the policy group further includes: a regulation target, including a target factor and a target value corresponding to the target factor, the regulation condition being associated with the regulation target; and the performing the regulation action corresponding to the regulation condition on a target object corresponding to the target object information when the regulation data meets the regulation condition, including:
replacing a value corresponding to the target factor in the regulation condition with the target value, to obtain a target regulation condition; and performing the regulation action on the target object when the regulation data meets the target regulation condition.

Based on the first example of the first aspect, in a fourth example of the first aspect, the policy group further includes a regulation weight corresponding to each policy; and the performing the regulation action corresponding to the regulation condition on a target object corresponding to the target object information includes:
classifying a plurality of policies into a plurality of groups based on regulation directions of regulation actions, where regulation actions in each group correspond to one regulation direction; adjusting the regulation weights of the policies on a per-group basis; and combining the regulation actions based on the regulation weights to obtain a comprehensive regulation action, and performing the comprehensive regulation action on the target object.

Based on the fourth example of the first aspect, in a fifth example of the first aspect, the adjusting the regulation weights of the policies on a per-group basis includes:
classifying a plurality of policies of each group into a plurality of sub-groups based on regulation actions, where regulation actions corresponding to each sub-group are the same; and decreasing a regulation weight of a target policy in each sub-group, where the target policy is a policy other than a policy with a largest regulation weight in the sub-group.

Based on the fifth example of the first aspect, in a sixth example of the first aspect, a decrease magnitude of the regulation weight of the target policy in each sub-group is negatively correlated with the regulation weight of the target policy.

Based on the first example of the first aspect, in a seventh example of the first aspect, the policy group further includes a policy execution condition, and the generating a query task based on the target object information and the regulation condition includes:
obtaining current scenario information based on the policy execution condition; and generating the query task based on the target object information and the regulation condition when the current scenario information meets the policy execution condition.

Based on the seventh example of the first aspect, in an eighth example of the first aspect, the policy execution condition includes: whether cold start is supported, an execution period, and a scope limit on the regulation action.

Based on the first example to the eighth example of the first aspect, in a ninth example of the first aspect, the obtaining a policy group includes:
obtaining a policy group in an enabled state and a policy in the enabled state from the policy group in the enabled state, where the policy group is in a disabled state when all the policies in the policy group are in the disabled state; and the policy group is in the enabled state when at least one policy in the policy group is in the enabled state.

In a first example of a second aspect, an embodiment of the present disclosure provides an object regulation apparatus, including:
a policy group obtaining module configured to obtain a policy group, where the policy group includes target object information and at least one policy, and the policy includes: a regulation condition and a regulation action that correspond to each other;
a regulation data obtaining module configured to generate a query task based on the target object information and the regulation condition, and perform the query task to obtain regulation data; and
a regulation execution module configured to perform the regulation action corresponding to the regulation condition on a target object corresponding to the target object information when the regulation data meets the regulation condition.

Based on the first example of the second aspect, in a second example of the second aspect, the regulation data obtaining module is further configured to:
extract a regulation factor from the regulation condition; determine a corresponding data table, a first field of the regulation factor in the data table, and a second field corresponding to the target object information in the data table based on the regulation factor; and generate a query statement corresponding to the query task based on the first field, the second field, and the data table, where the query statement is used to read the first field from the data table when the second field matches the target object information.

Based on the first example of the second aspect, in a third example of the second aspect, the policy group further includes: a regulation target, including a target factor and a target value corresponding to the target factor, the regulation condition being associated with the regulation target; and the regulation execution module is further configured to:
replace a value corresponding to the target factor in the regulation condition with the target value, to obtain a target regulation condition; and perform the regulation action on the target object when the regulation data meets the target regulation condition.

Based on the first example of the second aspect, in a fourth example of the second aspect, the policy group further includes a regulation weight corresponding to each policy; and the regulation execution module is further configured to:
classify a plurality of policies into a plurality of groups based on regulation directions of regulation actions, where regulation actions in each group correspond to one regulation direction; adjust the regulation weights of the policies on a per-group basis; and combine the regulation actions based on the regulation weights to obtain a comprehensive regulation action, and perform the comprehensive regulation action on the target object.

Based on the fourth example of the second aspect, in a fifth example of the second aspect, the regulation execution module is further configured to:
classify a plurality of policies of each group into a plurality of sub-groups based on regulation actions, where regulation actions corresponding to each sub-group are the same; and decrease a regulation weight of a target policy in each sub-group, where the target policy is a policy other than a policy with a largest regulation weight in the sub-group.

Based on the fifth example of the second aspect, in a sixth example of the second aspect, a decrease magnitude of the regulation weight of the target policy in each sub-group is negatively correlated with the regulation weight of the target policy.

Based on the first example of the second aspect, in a seventh example of the second aspect, the policy group further includes a policy execution condition; and the regulation data obtaining module is further configured to:
obtain current scenario information based on the policy execution condition; and generate the query task based on the target object information and the regulation condition when the current scenario information meets the policy execution condition.

Based on the seventh example of the second aspect, in an eighth example of the second aspect, the policy execution condition includes: whether cold start is supported, an execution period, and a scope limit on the regulation action.

Based on the first example to the eighth example of the second aspect, in a ninth example of the second aspect, the policy group obtaining module is further configured to:
obtain a policy group in an enabled state and a policy in the enabled state from the policy group in the enabled state, where the policy group is in a disabled state when all the policies in the policy group are in the disabled state; and the policy group is in the enabled state when at least one policy in the policy group is in the enabled state.

In a third aspect, according to one or more embodiments of the present disclosure, there is provided an electronic device. The electronic device includes: at least one processor and a memory.

The memory stores computer-executable instructions.

The at least one processor executes the computer-executable instructions stored in the memory, to cause the electronic device to implement the object regulation method of any one of the embodiments of the first aspect.

According to a fourth aspect, one or more embodiments of the present disclosure provide a computer-readable storage medium storing computer-executable instructions that, when executed by a processor, cause a computing device to implement the object regulation method of any one of the embodiments of the first aspect.

According to a fifth aspect, one or more embodiments of the present disclosure provide a computer program for implementing the object regulation method of any one of the embodiments of the first aspect.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An object regulation method, comprising:
obtaining a policy group, wherein the policy group comprises target object information and at least one policy, and the policy comprises: a regulation condition and a regulation action that correspond to each other;
generating a query task based on the target object information and the regulation condition, and performing the query task to obtain regulation data; and
performing the regulation action corresponding to the regulation condition on a target object corresponding to the target object information in response to the regulation data meeting the regulation condition.

2. The method according to claim 1, wherein the generating the query task based on the target object information and the regulation condition comprises:
extracting a regulation factor from the regulation condition;
determining a corresponding data table, a first field of the regulation factor in the data table, and a second field corresponding to the target object information in the data table based on the regulation factor; and
generating a query statement corresponding to the query task based on the first field, the second field, and the data table, wherein the query statement is used to read the first field from the data table when the second field matches the target object information.

3. The method according to claim 1, wherein the policy group further comprises: a regulation target comprising a target factor and a target value corresponding to the target factor, the regulation condition being associated with the regulation target; and
the performing the regulation action corresponding to the regulation condition on the target object corresponding to the target object information when the regulation data meets the regulation condition comprises:
replacing a value corresponding to the target factor in the regulation condition with the target value, to obtain a target regulation condition; and
performing the regulation action on the target object when the regulation data meets the target regulation condition.

4. The method according to claim 1, wherein the policy group further comprises a regulation weight corresponding to each policy; and
the performing the regulation action corresponding to the regulation condition on the target object corresponding to the target object information comprises:
classifying a plurality of policies into a plurality of groups based on regulation directions of regulation actions, wherein the regulation actions in each group correspond to one regulation direction;
adjusting the regulation weights of the policies on a per-group basis; and
combining the regulation actions based on the regulation weights to obtain a comprehensive regulation action, and performing the comprehensive regulation action on the target object.

5. The method according to claim 4, wherein the adjusting the regulation weights of the policies on the per-group basis comprises:
classifying the plurality of policies of each group into a plurality of sub-groups based on the regulation actions, wherein the regulation actions corresponding to each sub-group are the same; and
decreasing the regulation weight of a target policy in each sub-group, wherein the target policy is a policy other than a policy with a largest regulation weight in the sub-group.

6. The method according to claim 5, wherein a decrease magnitude of the regulation weight of the target policy in each sub-group is negatively correlated with the regulation weight of the target policy.

7. The method according to claim 1, wherein the policy group further comprises a policy execution condition, and the generating the query task based on the target object information and the regulation condition comprises:
obtaining current scenario information based on the policy execution condition; and
generating the query task based on the target object information and the regulation condition when the current scenario information meets the policy execution condition.

8. The method according to claim 7, wherein the policy execution condition comprises at least one of:
whether cold start is supported, an execution period, and a scope limit on the regulation action.

9. The method according to claim 1, wherein the obtaining the policy group comprises:
obtaining the policy group in an enabled state and the policy in an enabled state from the policy group in the enabled state, wherein
the policy group is in a disabled state when all policies in the policy group are in a disabled state; and
the policy group is in the enabled state when at least one policy in the policy group is in the enabled state.

10. An electronic device, comprising: at least one processor and a memory,
wherein the memory stores computer-executable instructions; and
the at least one processor executes the computer-executable instructions stored in the memory, to cause the electronic device to implement an object regulation method,
wherein the method comprises:
obtaining a policy group, wherein the policy group comprises target object information and at least one policy, and the policy comprises: a regulation condition and a regulation action that correspond to each other;
generating a query task based on the target object information and the regulation condition, and performing the query task to obtain regulation data; and
performing the regulation action corresponding to the regulation condition on a target object corresponding to the target object information when the regulation data meets the regulation condition.

11. A non-transitory computer-readable storage medium, storing computer-executable instructions that, when executed by a processor, cause a computing device to implement an object regulation method, wherein the method comprises:
obtaining a policy group, wherein the policy group comprises target object information and at least one policy, and the policy comprises: a regulation condition and a regulation action that correspond to each other;
generating a query task based on the target object information and the regulation condition, and performing the query task to obtain regulation data; and
performing the regulation action corresponding to the regulation condition on a target object corresponding to the target object information when the regulation data meets the regulation condition.

12. The electronic device according to claim 10, wherein the generating the query task based on the target object information and the regulation condition comprises:
extracting a regulation factor from the regulation condition;
determining a corresponding data table, a first field of the regulation factor in the data table, and a second field corresponding to the target object information in the data table based on the regulation factor; and
generating a query statement corresponding to the query task based on the first field, the second field, and the data table, wherein the query statement is used to read the first field from the data table when the second field matches the target object information.

13. The electronic device according to claim 10, wherein the policy group further comprises: a regulation target comprising a target factor and a target value corresponding to the target factor, the regulation condition being associated with the regulation target; and
the performing the regulation action corresponding to the regulation condition on the target object corresponding to the target object information when the regulation data meets the regulation condition comprises:
replacing a value corresponding to the target factor in the regulation condition with the target value, to obtain a target regulation condition; and
performing the regulation action on the target object when the regulation data meets the target regulation condition.

14. The electronic device according to claim 10, wherein the policy group further comprises a regulation weight corresponding to each policy; and
the performing the regulation action corresponding to the regulation condition on the target object corresponding to the target object information comprises:
classifying a plurality of policies into a plurality of groups based on regulation directions of regulation actions, wherein the regulation actions in each group correspond to one regulation direction;
adjusting the regulation weights of the policies on a per-group basis; and
combining the regulation actions based on the regulation weights to obtain a comprehensive regulation action, and performing the comprehensive regulation action on the target object.

15. The electronic device according to claim 14, wherein the adjusting the regulation weights of the policies on the per-group basis comprises:
classifying the plurality of policies of each group into a plurality of sub-groups based on the regulation actions, wherein the regulation actions corresponding to each sub-group are the same; and
decreasing the regulation weight of a target policy in each sub-group, wherein the target policy is a policy other than a policy with a largest regulation weight in the sub-group.

16. The electronic device according to claim 15, wherein a decrease magnitude of the regulation weight of the target policy in each sub-group is negatively correlated with the regulation weight of the target policy.

17. The electronic device according to claim 10, wherein the policy group further comprises a policy execution condition, and the generating the query task based on the target object information and the regulation condition comprises:
obtaining current scenario information based on the policy execution condition; and
generating the query task based on the target object information and the regulation condition when the current scenario information meets the policy execution condition.

18. The electronic device according to claim 17, wherein the policy execution condition comprises at least one of: whether cold start is supported, an execution period, and a scope limit on the regulation action.

19. The electronic device according to claim 10, wherein the obtaining the policy group comprises:
obtaining the policy group in an enabled state and the policy in an enabled state from the policy group in the enabled state, wherein
the policy group is in a disabled state when all policies in the policy group are in a disabled state; and
the policy group is in the enabled state when at least one policy in the policy group is in the enabled state.

20. The method according to claim 2, wherein the obtaining the policy group comprises:
obtaining the policy group in an enabled state and the policy in an enabled state from the policy group in the enabled state, wherein
the policy group is in a disabled state when all policies in the policy group are in a disabled state; and
the policy group is in the enabled state when at least one policy in the policy group is in the enabled state.
